(19) United States
(12) Patent Application Publication
(10) Pub. No.: US 2018/0220826 A1
(43) Pub. Date: Aug. 9, 2018

(54) AERIAL DELIVERY SYSTEM AND METHOD

(71) Applicant: Guy Sillings, Floyds Knobs, IN (US)

(72) Inventor: Guy Sillings, Floyds Knobs, IN (US)

(21) Appl. No.: 15/838,895

(22) Filed: Dec. 12, 2017

Related U.S. Application Data
(60) Provisional application No. 62/456,121, filed on Feb. 8, 2017.

(51) Int. Cl. A47G 29/122; B64C 39/02; G06Q 10/08; G08G 5/00

(52) U.S. Cl. CPC A47G 29/1225; B64C 39/024; G06Q 10/0832; B64C 2201/141; A47G 2029/1226; B64C 2201/128; G08G 5/0069

(57) ABSTRACT

An aerial delivery system includes an elongate member, a cover, a sensor, and a motorized actuator. The elongate member has both a top end and a bottom end, and is configured to receive items, particularly mail and packages, from a delivery means, particularly an aerial drone. The cover is removably attached to the top end of the elongate member, and is configured to allow entry of mail and packages into the elongate member. The sensor is also removably attached to the top end of the elongate member, and is configured to identify the delivery means.

### CROSS-REFERENCE TO RELATED APPLICATION(S)

The present application is related to and claims priority to U.S. Provisional Patent Application No. 62/456,121 filed Feb. 8, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of package delivery systems of existing art and more specifically relates to aerial package delivery systems for the home.

### RELATED ART

An unmanned aerial vehicle, commonly known as a drone, is an aircraft which operates without a pilot onboard. While unmanned aerial vehicles have been in development for some time, contemporary drones having high levels of autonomy are a relatively new technology. Drones vary significantly in structure, size, and function, and have been applied to a wide variety of uses ranging from surveillance, photography, and combat.

An important potential use for drones is the delivery of parcels and mail. Drones can be adapted to carry substantial payloads, and may do so with high autonomy and efficiency compared to traditional postal delivery services. However, drone deliveries face several potential problems with delivery methods, as it is difficult for an unmanned drone to determine a suitable landing zone. Additionally, packages left by a drone in the open in front of a home of commercial location may be vulnerable to theft. A suitable solution is desired.

U.S. Pat. No. 9,244,147 to Varun Soundararajan relates to an automated package delivery to a delivery receptacle. The described automated package delivery to a delivery receptacle includes a system for improving automated package delivery to mobile delivery receptacles to allow accurate and reliable package deliveries comprises a delivery receptacle for an automated package delivery via an unmanned aerial delivery device. The delivery receptacle is notified of a pending delivery and travels to a receiving location.

### SUMMARY OF THE INVENTION

In view of the foregoing disadvantages inherent in the known aerial package delivery art, the present disclosure provides a novel aerial delivery system and method. The general purpose of the present disclosure, which will be described subsequently in greater detail, is to provide an aerial delivery system and method.

An aerial delivery system is disclosed herein. The aerial delivery system includes an elongate member, a cover, a sensor, and a motorized actuator. The elongate member has both a top end and a bottom end, and is configured to receive items, particularly mail and packages, from a delivery means, particularly an aerial drone. The cover is removably attached to the top end of the elongate member, and is configured to allow entry of mail and packages into the elongate member. The sensor is also removably attached to the top end of the elongate member, and is configured to identify the delivery means. Preferably, the sensor identifies the delivery means through use of an infrared signal. The motorized actuator is removably attached to the cover, and is in electrical communication with the sensor, such that the motorized actuator opens the cover when the sensor identifies the delivery means. The elongate member may include a circular slide disposed inside the elongate member configured to allow passage of the items from the top end of the elongate member to the bottom end of the elongate member.

According to another embodiment, a method for receiving items delivered by an aerial drone is also disclosed herein. The method for receiving items delivered by an aerial drone includes firstly, providing the aerial delivery system; secondly, receiving a signal from an RFID tag attached to the aerial drone via the sensor; thirdly, opening the cover via the motorized actuator in response to the radio signal; fourthly, dropping mail or packages into the elongate member from the aerial drone; and fifthly, transferring the mail or packages from the top end of the elongate member to the bottom end of the elongate member.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an aerial delivery system and method, constructed and operative according to the teachings of the present disclosure.

FIG. 1 is a perspective view of the aerial delivery system during an ‘in-use’ condition, according to an embodiment of the disclosure.

FIG. 2 is a perspective view of the aerial delivery system of FIG. 1, according to an embodiment of the present disclosure.

FIG. 3 is a perspective view of the aerial delivery system of FIG. 1, according to an alternate embodiment of the present disclosure.

FIG. 4 is a perspective view of the aerial delivery system of FIG. 1, according to an embodiment of the present disclosure.

FIG. 5 is a flow diagram illustrating a method of use for receiving items delivered by an aerial drone, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an aerial package delivery system and more particularly to an aerial delivery system and method as used to improve the receiving of items delivered by an aerial drone.

Generally, aerial delivery system provides a home delivery chute for receiving packages from both ground and drone delivery services. It protects delivered packages from theft and inclement weather until the owner is able to retrieve the packages. In some embodiments, the delivery system attaches to the side of a house and is easily positioned in a desire location. Other embodiments may position the chute inside the structure, with the entry mechanism for the chute integrated into the roof. The system allows packages to be deposited safely and securely into the home after the package has been dropped into the chute. The system saves homeowners time and money by ensuring packages are kept secure until retrieval.

The aerial delivery system may include an elongate member with a top end and a bottom end for transferring a package. The elongate member includes a slide to gently transfer the package without risk of damage. Preferably, the slide comprises a spiral chute in order to comprise a compact system and provide structural support. A trapdoor mechanism is affixed to the top of the elongate member and is able to be opened and closed to accept packages from a drone. In a preferred embodiment, a sensor is configured to communicate with the drone using infrared or radio signals, and may open the trapdoor mechanism in response when an authorized drone is in proximity to the sensor. Additionally, at least one other door may be integrated into the system at ground level for receiving ground based deliveries. The doors may include locks to prevent unauthorized access.

Preferably, the elongate member and slide are constructed of rustproof materials, such as molded plastic or aluminum. The grade of the slide is critical to avoid blockage and/or damage to any fragile items. The chute, if attached to the house, may also include adjustable arms and an accordion expander to accommodate varying types and sizes of drones. In use, a delivery drone may drop the parcel into the top of the chute through the automatic lid. The chute will then safely transfer the package into the home or into the locked bottom portion. The device may be built OEM into a house or business or retrofitted to the home or business or not be attached to the home or business in alternate embodiments.

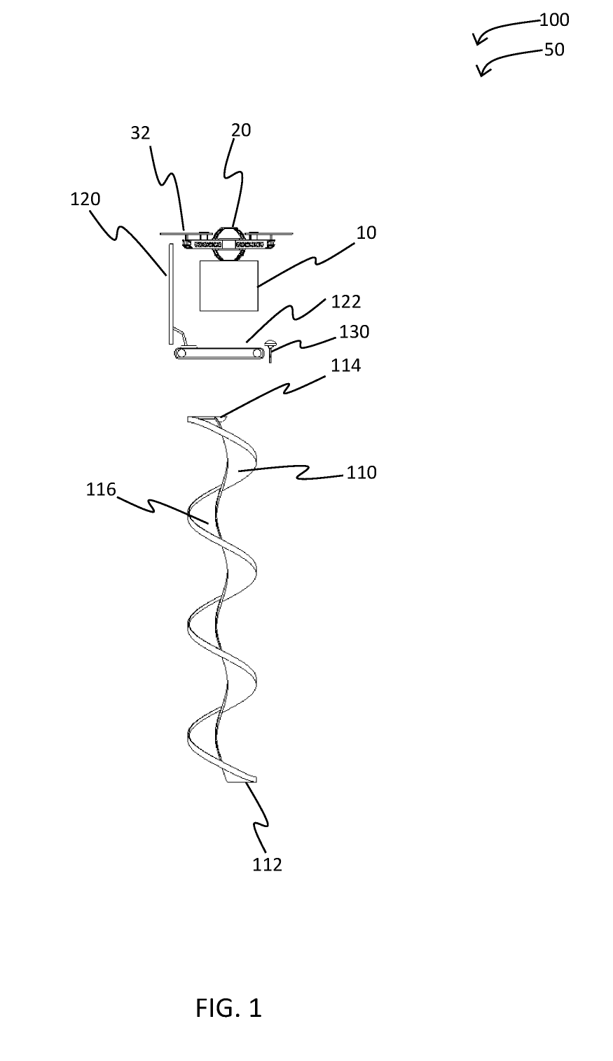

Referring now more specifically to the drawings by numerals of reference, there is shown in FIGS. 1-4, various views of apparatus 100.

FIG. 1 shows an apparatus 100 during an ‘in-use’ condition 50, according to an embodiment of the present disclosure. Here, the apparatus may be beneficial to safely and securely receive items. As illustrated, the apparatus 100 may include elongate member 110, cover 120, sensor 130, motorized actuator 122, and circular slide 116. Apparatus 100 is configured to receive items 10 from delivery means 20. Elongate member 110 includes top end 114 and bottom end 112, and is configured to receive items 10 from delivery means 20. Cover 120 is removably attached to top end 114 of elongate member 110, being configured to allow entry of items 10 into elongate member 110. Sensor 130 is removably attached to top end 114 of elongate member 110, and is configured to identify delivery means 20. Motorized actuator 122 is removably attached to cover 120, and is configured to be in electrical communication with sensor 130. Motorized actuator 122 is configured to open cover 120 when sensor 130 identifies delivery means 20. Circular slide 116 is disposed inside elongate member 110, such that circular slide 116 is configured to allow passage of items 10 from top end 114 of elongate member 110 to bottom end 112 of elongate member 110.

Upon reading this specification, it should be appreciated that, under appropriate circumstances, considering such issues as user preferences, design preference, structural requirements, marketing preferences, cost, available materials, technological advances, etc., other structural arrangements such as, for example, alternative shapes of the elongate member, alternative package receiving or retaining mechanisms, etc., may be sufficient.

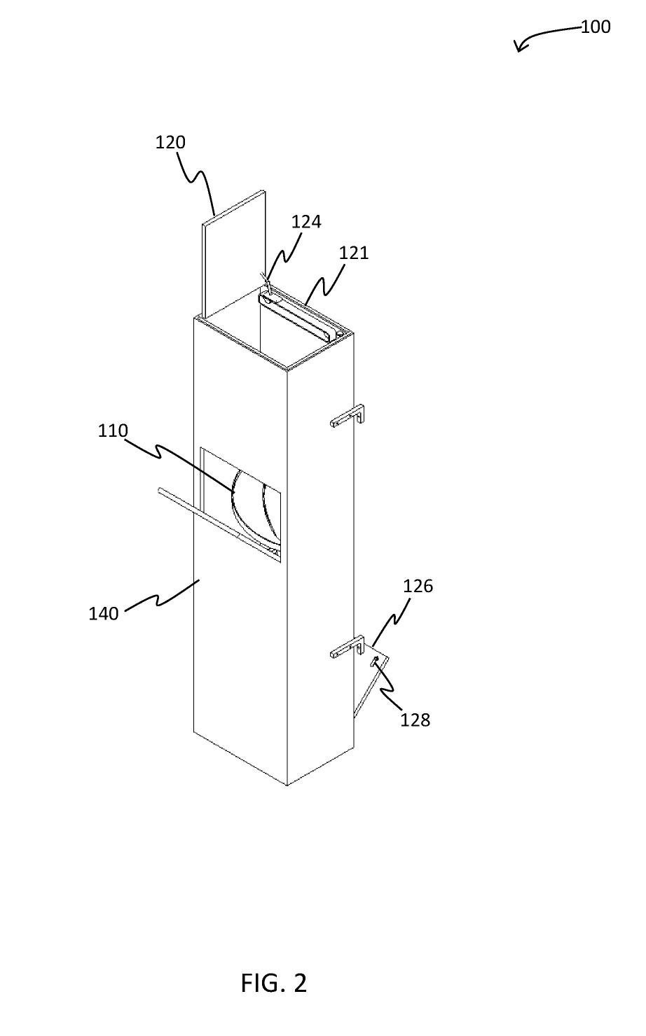

FIG. 2 shows the apparatus of FIG. 1, according to an embodiment of the present disclosure. Apparatus 100 further includes exterior wall 140 configured to shield elongate member 110. Delivery means may comprise a ground delivery. Apparatus 100 further includes at least one door 126 disposed on said elongate member 110. At least one door 126 includes mechanical lock 128 configured to prevent unauthorized entry. At least one door 126 is configured to allow ground delivery of items 10. Motorized actuator 122 (FIG. 1) includes hydraulic cylinder 124 configured to mechanically open and close cover 120. Cover 120 includes waterproof seal 121 configured to prevent entry of water into elongate member 110.

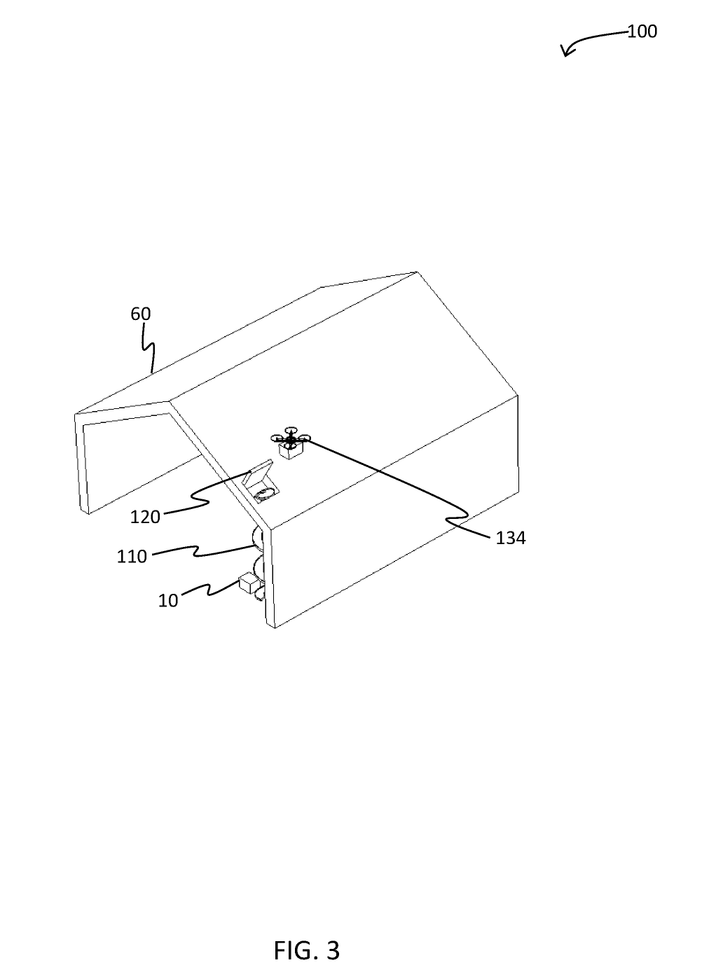

FIG. 3 is a perspective view of the apparatus of FIG. 1, according to an alternate embodiment of the present disclosure. Elongate member 110 is disposed inside structure 60. Additionally, cover 120 is integrated into structure 60. Elongate member 110 is a spiral chute. Cover 120 is a trapdoor integrated into structure 60. Delivery means 20 comprises an aerial drone delivery. Elongate member 110 is rust-proof. Circular slide 116 has a predetermined grade configured to avoid damage to items 10.

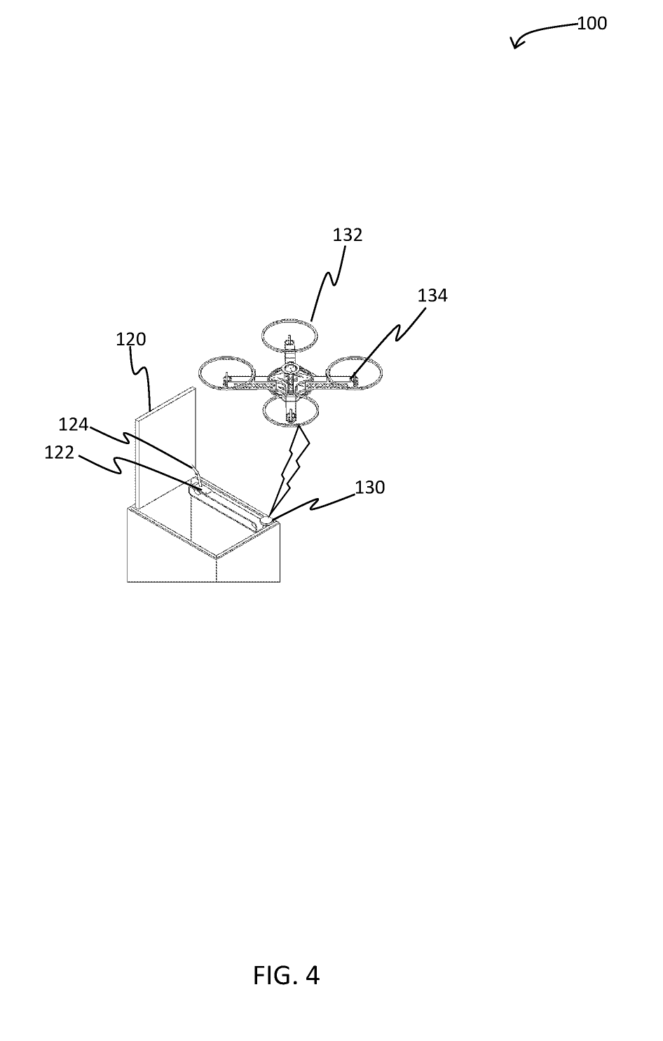

Referring now to FIG. 4 showing a perspective view of the apparatus of FIG. 1, according to an embodiment of the present disclosure. Aerial drone delivery 20 includes RFID identifier 132. Sensor 130 is a radio transceiver configured to communicate with RFID identifier 132 of aerial drone delivery 134. Cover 120 opens and closes automatically, and opens in response to communication of RFID identifier 132 of aerial drone delivery 134 with sensor 130.

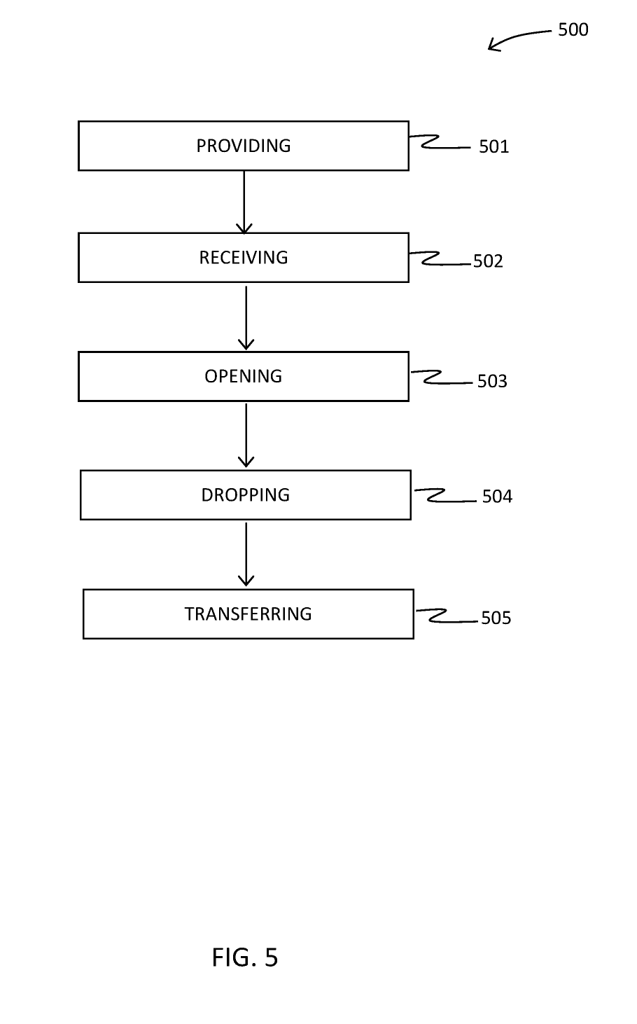

FIG. 5 is a flow diagram illustrating a method for receiving items delivered by an aerial drone, according to an embodiment of the present disclosure. In particular, the method for receiving items delivered by an aerial drone 500 may include one or more components or features of the apparatus 100 as described above. As illustrated, the method for receiving items delivered by an aerial drone 500 may include the steps of: step one 501, providing an apparatus comprising an elongate member having a top end and a bottom end, and wherein the elongate member is configured to receive the items from a delivery means; a cover, the cover being removably attached to the top end of the elongate member, and wherein the cover is configured to allow entry of the items into the elongate member; a sensor, the sensor removably attached to the top end of the elongate member, wherein the sensor is configured to identify the delivery means; and a motorized actuator, the motorized actuator being removably attached to the cover; wherein the motorized actuator is configured to be in electrical communication with the sensor; wherein the motorized actuator is configured to open the cover when the sensor identifies the delivery means; a circular slide, the circular slide disposed inside the elongate member and configured to allow passage of the items from the top end of the elongate member to the bottom end of the elongate member; step two 502, receiving a radio signal from an RFID tag of the aerial drone via the sensor; step three 503, opening the cover via the motorized actuator in response to the radio signal; step four 504, dropping the items into the elongate member from the aerial drone; and step five 505, transferring the items from the top end of the elongate member to the bottom end of the elongate member.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for receiving items delivered by an aerial drone, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An apparatus for receiving items, said apparatus comprising:
an elongate member having a top end and a bottom end, and wherein said elongate member is configured to receive said items from a delivery means;
a cover, said cover being removably attached to said top end of said elongate member, and wherein said cover is configured to allow entry of said items into said elongate member;
a sensor, said sensor removably attached to said top end of said elongate member, wherein said sensor is configured to identify said delivery means; and
a motorized actuator, said motorized actuator being removably attached to said cover;
wherein said motorized actuator is configured to be in electrical communication with said sensor;
wherein said motorized actuator is configured to open said cover when said sensor identifies said delivery means;
a circular slide, said circular slide disposed inside said elongate member and configured to allow passage of said items from said top end of said elongate member to said bottom end of said elongate member; and
wherein said apparatus is configured to receive said items from said delivery means.

2. The apparatus of claim 1, wherein said elongate member is a spiral chute.

3. The apparatus of claim 1, wherein said cover is a trapdoor.

4. The apparatus of claim 1, wherein said delivery means comprises an aerial drone delivery and alternately a ground delivery.

5. The apparatus of claim 1, wherein said apparatus further includes at least one door disposed on said elongate member.

6. The apparatus of claim 5, wherein said at least one door includes a mechanical lock configured to prevent an unauthorized entry.

7. The apparatus of claim 5, wherein said at least one door is configured to allow ground delivery of said items.

8. The apparatus of claim 1, wherein said motorized actuator includes a hydraulic cylinder configured to mechanically open and close said cover.

9. The apparatus of claim 1, wherein said cover includes a waterproof seal configured to prevent entry of water into said elongate member.

10. The apparatus of claim 4, wherein said aerial drone delivery includes a RFID identifier.

11. The apparatus of claim 10, wherein said sensor is a radio transceiver configured to communicate with said RFID identifier of said aerial drone delivery.

12. The apparatus of claim 1, wherein said elongate member is rust-proof.

13. The apparatus of claim 12, wherein said elongate member is made of molded plastic.

14. The apparatus of claim 12, wherein said elongate member is made of aluminum.

15. The apparatus of claim 1, wherein said circular slide has a predetermined grade configured to avoid damage to said items.

16. The apparatus of claim 1, wherein said cover opens and closes automatically.

17. An apparatus for receiving items, said apparatus comprising:
an elongate member having a top end and a bottom end, and wherein said elongate member is configured to receive said items from a delivery means;
a cover, said cover being removably attached to said top end of said elongate member, and wherein said cover is configured to allow entry of said items into said elongate member;
a sensor, said sensor removably attached to said top end of said elongate member, wherein said sensor is configured to identify said delivery means; and
a motorized actuator, said motorized actuator being removably attached to said cover;
wherein said motorized actuator is configured to be in electrical communication with said sensor;
wherein said motorized actuator is configured to open said cover when said sensor identifies said delivery means;
a circular slide, said circular slide disposed inside said elongate member and configured to allow passage of said items from said top end of said elongate member to said bottom end of said elongate member;
wherein said apparatus is configured to receive said items from said delivery means;
wherein said elongate member is a spiral chute;
wherein said cover is a trapdoor;
wherein said delivery means comprises an aerial drone delivery;
wherein said apparatus further includes at least one door disposed on said elongate member;
wherein said at least one door includes a mechanical lock configured to prevent an unauthorized entry;
wherein said motorized actuator includes a hydraulic cylinder configured to mechanically open and close said cover;
wherein said cover includes a waterproof seal configured to prevent entry of water into said elongate member;
wherein said aerial drone delivery includes a RFID identifier;
wherein said sensor is a radio transceiver configured to communicate with said RFID identifier of said aerial drone delivery;
wherein said elongate member is rust-proof;
wherein said circular slide has a predetermined grade configured to avoid damage to said items; and
wherein said cover opens and closes automatically.

18. A method for receiving items delivered from an aerial drone, the method comprising the steps of:
providing an apparatus comprising an elongate member having a top end and a bottom end, and wherein said elongate member is configured to receive said items from a delivery means; a cover, said cover being removably attached to said top end of said elongate member, and wherein said cover is configured to allow entry of said items into said elongate member; a sensor, said sensor removably attached to said top end of said elongate member, wherein said sensor is configured to identify said delivery means; and a motorized actuator, said motorized actuator being removably attached to said cover; wherein said motorized actuator is configured to be in electrical communication with said sensor; wherein said motorized actuator is configured to open said cover when said sensor identifies said delivery means; a circular slide, said circular slide disposed inside said elongate member and configured to allow passage of said items from said top end of said elongate member to said bottom end of said elongate member;
receiving a radio signal from an RFID tag of said aerial drone via said sensor;
opening said cover via said motorized actuator in response to said radio signal;
dropping said items into said elongate member from said aerial drone; and
transferring said items from said top end of said elongate member to said bottom end of said elongate member.
